(19) United States
(12) Patent Application Publication
(10) Pub. No.: US 2025/0003880 A1
(43) Pub. Date: Jan. 2, 2025

(54) RAMAN SPECTROSCOPY OF CHEMICAL PROCESSES WITH SPECTRAL BLOCKING FILTERS

(71) Applicant: Tornado Spectral Systems Inc., Mississauga (CA)

(72) Inventors: Shaun Fraser, Etobicoke (CA); Bradford B. Behr, Silver Spring, MD (US); Mark Kemper, Adrian, MI (US)

(21) Appl. No.: 18/695,106

(22) PCT Filed: Sep. 23, 2022
(86) PCT No.: PCT/CA22/51415

§ 371 Date: Mar. 25, 2024

Related U.S. Application Data
(60) Provisional application No. 63/248,480, filed on Sep. 25, 2021.

(51) Int. Cl. G01N 21/65; G01N 21/84; G01N 21/88

(52) U.S. Cl. CPC G01N 21/65; G01N 21/88; G01N 2021/8416

(57) ABSTRACT

Various embodiments are provided herein for a Raman analyzer system and associated method of analyzing a chemical process including a supercritical fluid extraction process or a solvent extraction process using a Raman analyzer system where the method involves generating light stimuli and providing the light stimuli to a sample of the chemical process; collecting scattered light from the sample; filtering the scattered light using one or more selected optical filters for selectively attenuating one or more wavelength sections for Raman analysis; detecting the filtered light; and generating one or more filtered Raman spectra of the detected light.

### CROSS-REFERENCE TO RELATED PATENT APPLICATION

This application claims the benefit of U.S. Provisional Patent Application No. 63/248,480 filed Sep. 25, 2021; the entire contents of U.S. Provisional Patent Application No. 63/248,480 is hereby incorporated herein in its entirety.

### FIELD

Various embodiments are described herein that generally relate to the field of Raman spectroscopy and more specifically relates to optical processing and Raman analysis for improved analyte detection and/or measurement.

### BACKGROUND

Supercritical fluid extraction and solvent extraction are widely-used methods in industries such as food processing, nutrition, pharmaceuticals, cannabis, biofuels and waste treatment. The commercially valuable extracts, resins, and oils can be efficiently separated from a source feedstock using an appropriate solvent and an extractor cycle including pressurized vessels, heat exchangers, and condensers. The pressure and temperature at each stage in the cycle strongly influence the speed and completeness of the extraction process, so it is highly advantageous to have real-time feedback about the chemical composition of the mixture, e.g., to determine whether extraction has completed, if contaminants have built up to unacceptable levels, or if the temperature and/or pressure should be adjusted. Various modalities exist for offline measurement, such as gas chromatography (GC) and high performance liquid chromatography (HPLC), but even better is an in situ chemical quantification method such as Raman spectroscopy.

Raman spectroscopy involves the illumination of a sample with a laser and detailed spectroscopic analysis of the scattered light returning to the apparatus from the sample illumination region. A small fraction of the laser photons will be shifted in wavelength (to either longer or shorter wavelengths) by interactions with the functional groups of the molecules, with the amount of “Raman shift” being highly specific to the molecules in question. The spectrum of the scattered light, as measured by a Raman spectrometer device, therefore shows peaks or bands at specific wavelengths or wavenumbers which can be used to identify which molecular species are present in the sample. Furthermore, with appropriate calibration, the heights of these Raman spectral peaks can be used to determine the quantitative proportions of each chemical component of a mixture, including the chemical components of interest (hereafter referred to as the “analytes” or “extractants”) in a supercritical fluid extraction process or solvent extraction process, thereby providing the real-time in situ measurements needed to optimize the parameters and configuration of said process for maximum yield, fastest speed, or other attribute of interest. Likewise, other chemical processes may be controlled or improved based upon information gleaned from Raman measurements taken during the course of the process. The measured Raman spectral range typically includes the so-called “fingerprint region” of 200 to 1800 cm⁻¹ and the “CH stretch region” of 2700 to 3300 cm⁻¹, where the wavenumber unit “inverse centimeters” or cm⁻¹ is commonly used to quantify the amount of Raman shift from the laser wavelength used to excite the target molecules in the sample.

However, one significant limitation to the Raman spectroscopy method is that the extraction solvents, or for a chemical process, in general, the other chemical components of the mixture each have their own Raman spectral signature, with Raman peaks and bands that may be significantly stronger than those of the analytes. The solvent peaks or other strong peaks will dominate the dynamic range of the detector on the Raman spectrometer, such that the analyte peaks appear very small and are difficult to detect or measure precisely.

### SUMMARY OF VARIOUS EMBODIMENTS

According to one aspect of the teachings herein, there is provided at least one embodiment of a method of analyzing a chemical process including a supercritical fluid extraction process or a solvent extraction process, using a Raman analyzer system wherein the method comprises: generating light stimuli and providing the light stimuli to a sample of the chemical process; collecting scattered light from the sample; filtering the scattered light using one or more optical filters for selectively attenuating one or more wavelength sections for Raman analysis; detecting the filtered light; and generating one or more filtered Raman spectra of the detected light.

In at least one embodiment, the solvent comprises C3-8 alcohol, a hydrocarbon, a supercritical fluid, ethanol, isopropanol, butane, acetone, a hydrofluorocarbon, R-134a, n-propane, isopropane, cyclopropane, n-butane, isobutane, hexane, pentane, isobutylene, glycerin, propylene glycol, supercritical carbon dioxide, or any combination thereof.

In at least one embodiment, the method comprises performing the optical filtering using an adjustable optical filter unit having one or more shortpass optical filters, one or more longpass optical filters, one or more notch optical filters, or any combination thereof, which attenuate at least a portion of the one or more Raman spectra over one or more continuous or discontinuous spectral ranges.

In at least one embodiment, the method comprises moving the one or more optical filters in and out of a collection light beam path for filtering the collected scattered light to attenuate different wavelength regions that correspond to Raman bands of one or more solvents, or to improve measurement of Raman bands of one or more different analytes.

In at least one embodiment, the method comprises moving the one or more optical filters by means of: a rotating filter wheel or a translating filter stage which each insert or remove the one or more optical filters from the collection light beam path.

In at least one embodiment, the method comprises using a computing device or an automatic sequencing apparatus to generate a filter control signal for controlling motion of the one or more optical filters.

In at least one embodiment, the one or more optical filters include at least one tunable optical filter and the method comprises using a computing device or an automatic sequencing apparatus to generate a filter control signal to change a passband and/or attenuation region of the at least one tunable optical filter.

In at least one embodiment, the method comprises selecting the one or more optical filters to attenuate Raman bands of one or more solvents and/or one or more analytes in the sample in order to detect Raman bands of contaminants in the sample obtained from the chemical process.

In at least one embodiment, the method comprises selecting the one or more optical filters to attenuate one or more wavelength ranges in the collected scattered light so that the generated Raman spectra only include one or more Stokes-shifted Raman bands or one or more anti-Stokes-shifted Raman bands.

In at least one embodiment, prior to collecting and filtering scattered light from the sample, the method further comprises: acquiring one or more full Raman spectra from the sample without any adjustable optical filtering; and selecting one or more data acquisition parameters and/or a configuration for the one or more optical filters based on one or more characteristics of the one or more full Raman spectra.

In at least one embodiment, after generating the one or more full Raman spectra the method further comprises determining whether to acquire additional full Raman spectra without any adjustable optical filtering, selecting other values for data acquisition parameters and/or another configuration for the one or more optical filters based on positions, amplitudes, and/or other characteristics of bands and/or peaks which appear in the additional full Raman spectra.

In at least one embodiment, the method further comprises monitoring and/or controlling the chemical process using chemical information derived from the one or more filtered Raman spectra.

In at least one embodiment, the method comprises: acquiring Raman spectral data using an optical filter configuration for the one or more optical filters to permit measurement of a Raman spectral range including a fingerprint region and a CH stretch region; acquiring additional Raman spectral data using a different optical filter configuration to block Raman bands of one or more solvents or other Raman bands having largest amplitudes in the Raman spectra range, and using data acquisition settings to enable spectral measurements with increased sensitivity by increasing exposure time, and/or increasing gain to permit a partial spectral range including Raman bands of one or more analytes to be measured; and determining whether to continue the chemical process and perform the analysis based on the Raman spectral data based on a comparison of measurements of the one or more analytes to a threshold.

In at least one embodiment, the method further comprises: acquiring further Raman spectral data using another optical filter configuration to attenuate Raman bands of the one or more solvents and/or the one or more analytes, and using other data acquisition settings to enable spectral measurements having increased sensitivity by increasing exposure time and/or gain to permit another partial spectral range including Raman bands of other potential constituents of the process to be measured.

In another aspect, in accordance with the teachings herein, there is provided at least one embodiment of a Raman analyzer system for analyzing a chemical process including a supercritical fluid extraction process or a solvent extraction process, wherein the Raman analyzer system comprises: a light source that is configured to generate light stimuli; an optical probe that is coupled to the light source for providing the light stimuli to a sample of the chemical process and collecting scattered light from the sample; an adjustable optical filter unit that is coupled to the optical probe, the adjustable optical filter unit including one or more optical filters for selectively filtering the scattered light by adjusting the one or more optical filters for selectively attenuating one or more wavelength sections for Raman analysis; a spectrometer that is coupled to the adjustable optical filter unit for detecting the filtered light and generating one or more filtered Raman spectra of the detected light; and a computing device that is coupled to the spectrometer, the light source and the adjustable optical filter unit and configured for controlling Raman measurements of the sample.

In at least one embodiment, the adjustable optical filter unit comprises one or more shortpass optical filters, one or more longpass optical filters, one or more notch optical filters, or any combination thereof, which attenuate at least a portion of the one or more Raman spectra over one or more continuous or discontinuous spectral ranges.

In at least one embodiment, the one or more optical filters are moveable into and out of a collection light beam path for filtering the collected scattered light to attenuate different wavelength regions that correspond to Raman bands of one or more solvents, or to improve measurement of Raman bands of one or more different analytes.

In at least one embodiment, the adjustable optical filter unit comprises a rotating optical filter wheel or a translating optical filter stage that are each configured to insert or remove the one or more optical filters from the collection light beam path.

In at least one embodiment, the computing device is configured to generate a filter control signal for controlling motion of the one or more optical filters.

In at least one embodiment, the adjustable optical filter unit comprises one or more tunable optical filters that are tunable to suppress, block, and/or transmit different light wavelengths corresponding to one or more regions of a Raman spectrum, depending on passband characteristics of the one or more optical filters that optically filter the scattered light.

In at least one embodiment, the computing device is configured to generate a filter control signal to change a passband and/or attenuation region of the at least one tunable optical filter.

In at least one embodiment, the computing device is configured to select the one or more optical filters to attenuate Raman bands of one or more solvents and/or one or more analytes in the sample in order to detect Raman bands of contaminants in the sample obtained from the chemical process.

In at least one embodiment, the one or more optical filters are selected to attenuate one or more wavelength ranges in the collected scattered light so that the generated Raman spectra only include one or more Stokes-shifted Raman bands or one or more anti-Stokes-shifted Raman bands.

In at least one embodiment, the adjustable optical filter unit is located in the optical probe, in the spectrometer, between the optical probe and the spectrometer, or a combination thereof.

In another aspect, in accordance with the teachings herein, there is provided at least one embodiment of a use of a Raman analyzer system with an adjustable optical filter unit for generating filtered Raman spectral data to monitor and/or control a process for extracting specific analytes from a feedstock using one or more solvents.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIGS. 1A-1C show various example embodiments of Raman spectrometry systems that incorporate optical filtering.

FIG. 2 shows a flow chart of an example embodiment of a Raman spectral analysis method that incorporates optical filtering.

FIGS. 3A-3D show experimental results when optical filters are incorporated into Raman spectrometry.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, an optical or an electrical connotation. For example, as used herein, the terms coupled or coupling can indicate that two elements or devices can be directly connected to one another or connected to one another through one or more intermediate elements or devices via an electrical signal, an electrical connection, a mechanical element, an optical element, or a light pathway depending on the particular context.

It should also be noted that, as used herein, the wording “and/or” is intended to represent an inclusive-or. That is, expressions such as “X and/or Y” are intended to generally mean X or Y or both, for example. As a further example, expressions such as “X, Y, and/or Z” are intended to generally mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

The embodiments of the systems and methods described herein are implemented using a combination of hardware and software. The embodiments described herein may be implemented with computer programs executing on programmable devices, each programmable device including at least one processor, a data storage system (including volatile memory or non-volatile memory or other data storage elements or a combination thereof), and at least one communication interface. For example, and without limitation, the programmable devices may be a server, a network appliance, an embedded device, a personal computer, a laptop, a personal data assistant, a smart-phone device, a tablet computer, programmable logic controller, or any other computing device or automatic sequencing apparatus capable of being configured to carry out the methods described herein (e.g., through execution of one or more computer program(s) that embody one or more of these methods) where these devices may communicate using wired or wireless communications protocols as appropriate.

Program code may be applied to input data to perform the functions described herein and to generate output data. The output data may be displayed to a user via one or more output devices and/or electronically communicated to another devices. Each program may be implemented in a high-level procedural or object-oriented programming and/or scripting language, or both, to communicate with a computer system. The program code may be written in C⁺⁺, C#, JavaScript, Python, MATLAB, or any other suitable programming language and may comprise modules or classes, as is known to those skilled in object-oriented programming. In either case, the language may be a compiled or interpreted language. However, the programs may be implemented in assembly or machine language, if desired. In any case, the language may be a compiled or an interpreted language in at least one embodiment. Each such computer program may be stored on a non-transitory computer-readable storage medium (e.g., ROM, magnetic disk, optical disc, USB drive) that is readable by a general or special purpose computing device, for configuring and operating the computing device when the storage media or device is read by the computing device to perform one or more of the procedures in accordance with the teachings herein.

Furthermore, the functionality of the methods of the described embodiments are capable of being distributed in one or more computer program products comprising a computer readable medium that bears computer usable instructions for one or more processors. The medium may be provided in various forms, including non-transitory forms such as, but not limited to, one or more diskettes, compact disks, tapes, chips, USB drives, and magnetic and electronic storage media as well as transitory forms such as, but not limited to, wireline transmissions, satellite transmissions, internet transmission or downloads, digital and analog signals, and the like. The computer useable instructions may also be in various forms, including compiled and non-compiled code.

As previously mentioned, chemical quantification methods such as Raman spectroscopy may be used to monitor and/or control chemical processes including but not limited to supercritical fluid extraction and solvent extraction which may be used to separate commercially valuable extracts, resins, and oils from a source feedstock in a variety of different applications/fields. Other chemical processes which may also benefit from real-time feedback regarding products or contaminants relevant to such chemical processes include, but are not limited to, polymerization reactions, reactant consumption, petrochemical quality control, microbial or bacterial fermentations for bioprocessing, wastewater monitoring and treatment, or determining drug load of active pharmaceutical ingredients (APIs) in medicines. These examples should not be taken to limit the scope of the teachings herein, which may be applied to any chemical process or reaction, including those with inputs and/or outputs which are biological, mineral, petroleum, polymer, inorganic, or fine chemical in nature.

However, Raman spectra of samples obtained using solvents have Raman peaks and/or bands due to the solvents in the samples, where at least one of these peaks and/or bands may be significantly stronger (for example, the terms “strong” or “stronger” may mean, but is not limited to, having maximum intensities from 10 times greater to 1000 times greater) than those of the analytes such that the analyte peaks appear very small and may be difficult to detect and/or measure precisely. If the exposure time of the Raman spectrometer is increased to make the analyte peaks more prominent, this may cause the solvent peaks to “saturate”, exceeding the linear measurement range of the spectrometer detector and possibly contaminating the regions of the detector which measure the analyte peaks. For example, on a detector utilizing a charge-coupled device, or CCD, “bleeding” of excess photoelectrons spilling over from one pixel to adjacent pixels causes this contamination. Thus, there exists an unfortunate and potentially limiting tradeoff between the weak Raman bands and/or peaks of the analytes and the strong Raman bands and/or peaks of the solvents or the other components of the chemical mixture.

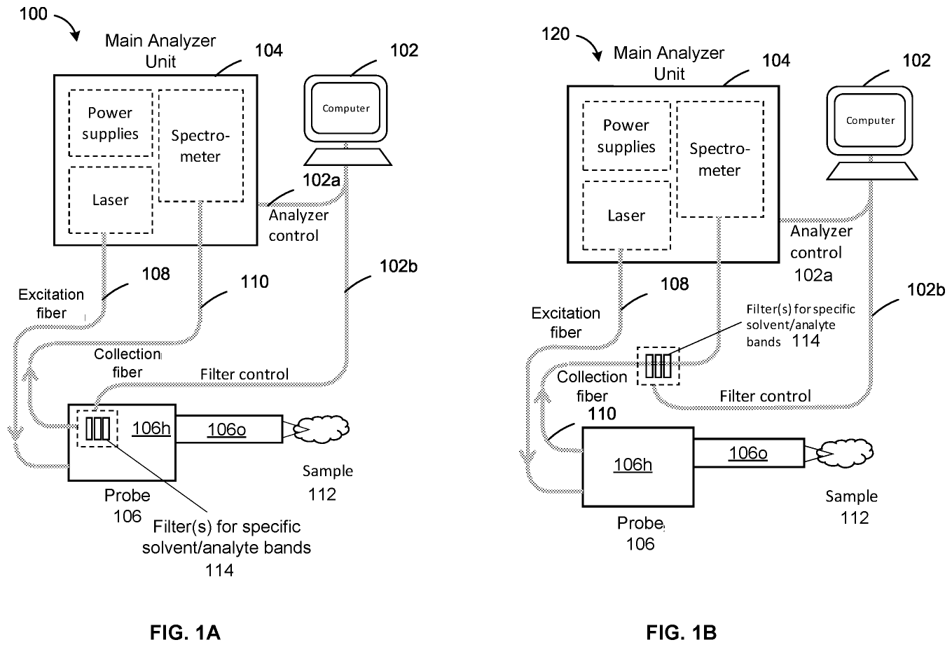

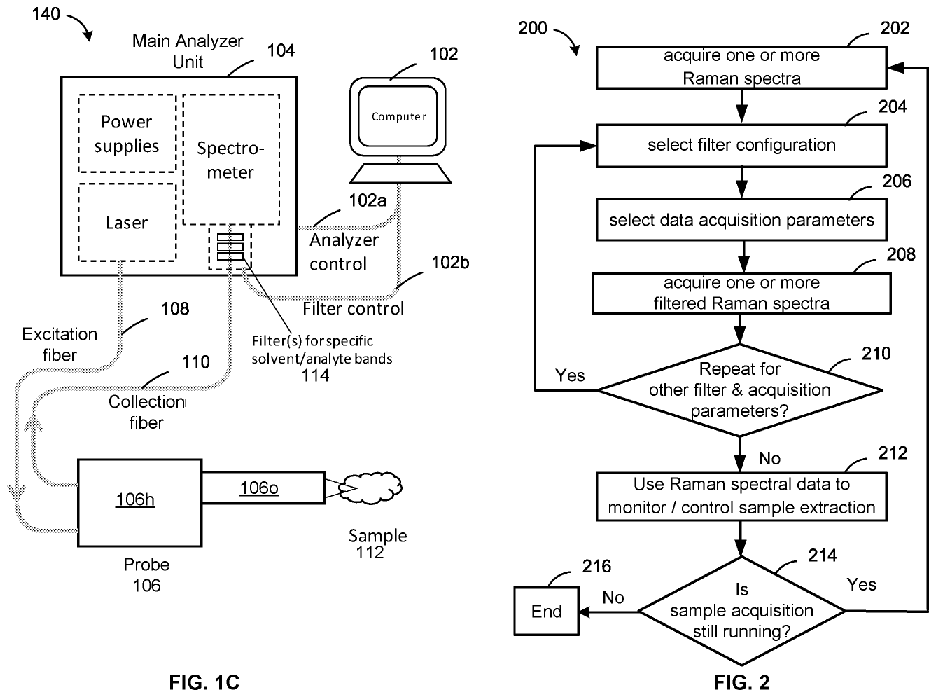

In accordance with one aspects of the teachings herein, the inventors have discovered a solution to mitigate this tradeoff, which involves the use of a novel optical configuration which generally suppresses or blocks one or more of the spectral ranges of the Raman spectrum which contain the strong bands and/or peaks of a particular solvent, such that the weak bands of the analytes of interest can be measured with greater sensitivity and fidelity. This suppression or blocking may be done over one or more continuous or discontinuous spectral ranges. This suppression or blocking is achieved by use of one or more optical filters, such as a bandpass optical filter, for example, located in the Raman probe, the Raman spectrometer, or a separate unit between the probe and spectrometer. FIGS. 1A-1C show examples of various embodiments of a Raman analyzer system that incorporates adjustable optical filtering. In FIG. 1A, an adjustable optical filter unit is built into the Raman probe, located in the beam path leading to the collection fiber. In FIG. 1B, the adjustable optical filter unit is located in between the Raman probe and the spectrometer, operating upon the light travelling through the collection fiber. In FIG. 1C, the adjustable optical filter unit has been incorporated into the spectrometer, operating upon the light beam carrying the Raman spectral signal as it enters the spectrometer, or within the spectrometer itself. In any of these cases, the adjustable optical filter unit may be under the control of a computing device such as, but not limited to, a laptop computer, or a desktop computer, for example, such that different optical filters or optical filter combinations can be automatically selected and synchronized with the acquisition of spectral data by the Raman analyzer.

In at least one embodiment, the adjustable optical filter unit may include a motorized mechanism, such as, but not limited to, a stepper motor or linear motor stage, which may be controlled by the computing device via serial, USB, or other communications protocol. For example, different optical filters in the adjustable optical filter unit may be introduced (e.g., linearly translated, rotated, etc.) into the collection light beam path under control of the computing device as part of a pre-programmed sequence or in response to the computing device's analysis of the Raman spectra, for instance.

The location of the adjustable optical filter unit is typically driven by the design constraints of the rest of the full analyzer system, e.g., whether there is room inside an existing spectrometer device to add the adjustable optical filter unit. Any of these embodiments may be used for analyzing the solvent/analyte mixture in an extraction process using any of a variety of one or more solvent types and that contain a variety of any one or more analyte types, or for analyzing the chemical concentrations of the constituents of a mixture in a chemical process in general.

Referring now to FIG. 1A, shown therein is a Raman analyzer system 100, which may be referred to as a Raman spectrometer, which generally comprises a computing device 102, such as a laptop or a desktop computer, a main analyzer unit 104, a probe 106 that is connected to the main analyzer unit 104 via multiple optical fiber cables including: an “excitation fiber” 110 for transmitting light energy, such as laser energy, from the main analyzer unit 104 to the probe 106 and a “collection fiber” 110 for transmitting the scattered light signal collected by the probe 106 from a sample 112 back to the main analyzer unit 104. The Raman analyzer system 100 also includes an adjustable optical filter unit 114 having one or more optical filters that is generally adjustable to provide for optical filtering in one or more selected spectral regions of the scattered light signal collected by the probe 106.

The main analyzer unit 104 generally includes a spectrometer, a light source, such as a laser, and power supplies. The laser provides energy for “exciting” molecular vibrations in the sample 112 by generating light stimuli that are delivered to the sample 112. The laser may be a diode laser, a diode-pumped solid state laser, a gas laser, or any other device for generating substantially monochromatic coherent light. The spectrometer may be a dispersive spectrometer, a Fourier Transform spectrometer, a Spatial Heterodyne Spectrometer, or any other device for measuring the spectral energy distribution of a light source or light beam. The spectrometer detects and quantifies light intensity at different wavelengths or wavenumbers in the scattered light spectrum for light that is scattered from the sample 112 and travels to the spectrometer via the collection light beam path. The one or more power supplies provide electricity to the electrical and/or electronic components of the laser and the spectrometer as required for their functioning.

The probe 106 is further divided into two parts, the “probe head” 106h and the “sample optic” 1060. The probe head 106h typically contains optical elements for collimating a diverging laser light beam that is provided from the excitation fiber 108 and directing this collimated beam to the sample optic 1060, which may, for example, be a focusing lens, a flat window, or other suitable optical elements. Other optical elements within the probe head 106h may include a dichroic filter for receiving and filtering at least one collimated beam of scattered light returning from the sample optic 1060 (e.g., after reflection from the sample 112), an additional bandpass optical filter to remove non-Raman-scattered light, and a collection focuser which then focuses the filtered scattered return light down into the collection fiber 110. In standard embodiments of the probe 106, all of these internal optical filters are fixed in terms of passbands and stopbands, in contrast to the switchable or adjustable optical filter unit 114.

For the sample optic 1060 (also sometimes referred to as the objective optic, non-contact optic, or immersion optic), current state-of-the-art typically involves the use of a single plano-convex or biconvex lens. In these types of Raman probe sample optics, the lenses have one or more surfaces which are parts of a sphere, or a lens which is a complete sphere. Such optical elements are called “spherical optics” by those skilled in the art, even when the optical elements do not comprise a complete sphere.

For some spectroscopic measurement applications, it is advantageous for the excitation light to illuminate a relatively large area or volume of the sample 112. This goal may be achieved by removing the focusing sample optic altogether such that the sample 112 is illuminated directly by the collimated excitation light beam, and some of this light is back-scattered from the sample 112 to create substantially collimated afocal returning scattered light beams which travel back into the probe head 106h and at least one of these returning beams is focused by the internal optics of probe head 106h onto a collection light beam path which includes the collection fiber 110. All other light beams scattered from the sample 112 are absorbed or reflected elsewhere and thus are not transmitted by the collection fiber 110 to the spectrometer of the main analyzer unit 104 for measurement. Although this optical configuration typically cannot capture as much of the backscattered light from the sample 112 as a focused spectroscopy probe might, this embodiment allows for a larger area (for an opaque sample) or larger volume (for a transparent sample) of the sample 112 to be illuminated compared to the focused spectroscopy probe, which means that a Raman analyzer system that analyzes the backscattered light is getting a more representative view of the sample 112 as a whole, rather than focusing in on a small and potentially non-representative region of the sample 112.

In accordance with another aspect of the teachings herein, the adjustable optical filter unit 114, which may include a single optical filter, or two or more optical filters, is physically positioned in the Raman analyzer system 100 in order to aid in the detection and/or measurement of the concentration of at least one analyte for a specific solvent/analyte combination or chemical mixture, or measurement of a general property of the sample (such as, but not limited to, the octane number of a gasoline sample, or the viable cell density of a fermentation process, for example). In other example embodiments, the adjustable optical filter unit 114 may include multiple filters, such as but not limited to, one or more shortpass optical filters, one or more notch optical filters, one or more longpass optical filters, or combinations thereof, in a switchable arrangement such as, but not limited to, a rotating optical filter wheel or a translating optical filter slide stage, which may be manually or automatically actuated. For example, the system 100 may include a motor to rotate the optical filter wheel to move one or more of the optical filters in the optical filter wheel into the collection light beam path. In the translating optical filter slide stage embodiment, all of the optical filters may be lined up side-by-side in a row with a motor or actuator to slide various optical filters of the assembly (i.e., the filter slide stage) back and forth linearly to move one or more of the optical filters into the collection light beam path during measurement of the light received in the collection light beam path. For both the optical filter wheel and optical filter slide stage embodiments, there may be one or more positions which contain no optical filter, such that the light in the collection light beam path passes through the adjustable optical filter unit 114 without being spectrally filtered.

The switchable arrangement of the adjustable optical filter unit 114 is used to provide switchable optical filtering that is controlled/selected by a user or by an automated control system, to allow the Raman analyzer system 100 to switch or change the attenuated spectral range(s) of the light received in the collection light beam path to increase sensitivity in performing analyte detection and/or analyte measurement for samples containing different solvents and/or different analytes, or permit spectroscopic measurement of one or more Raman bands including a Raman spectral range having a fingerprint region and a CH stretch region or at least one solvent Raman band; by the Raman analyzer system 100 to determine one or more solvent properties, which include, but is not limited to, solvent concentration, solvent purity, and/or solvent peak shifts (indicative of the presence of water). By way of example, optical filtering for a supercritical CO₂ solvent may involve configuring the adjustable optical filter unit 114 to block a spectral region including 1286 cm⁻¹ and 1388 cm⁻¹, which are the locations of the two main Raman bands of CO₂, while another adjustable optical filter may be used to suppress any spectral components for an isopropanol solvent by blocking a spectral region around 820 cm⁻¹, which is the location of the strongest (e.g., largest) Raman band of isopropanol.

It should be noted that the term “attenuate” as used herein with respect to spectral filtering provided by one or more optical filters, is meant to include cases where the filtering is done to suppress the Raman signal in one or more frequency bands of the light travelling in the collection light beam path by a certain amount, e.g., from about 1% to about 99.99%, or to block, for example, by more than about 99.99%, the Raman signal in one or more frequency bands of the light travelling in the collection light beam path.

In at least one embodiment, the solvent may include C3-8 alcohol, a hydrocarbon, a supercritical fluid, or a combination thereof.

In at least one embodiment, the solvent may include ethanol, isopropanol, butane, acetone, a hydrofluorocarbon, R-134a, n-propane, isopropane, cyclopropane, n-butane, isobutane, hexane, pentane, isobutylene, glycerin, propylene glycol, supercritical carbon dioxide, or a combination thereof.

In further embodiments, one or more optical filters of the adjustable optical filter unit 114 may be selected to attenuate (e.g., suppress or block) at least a portion of spectral ranges corresponding to one or more Raman bands and/or peaks of both of one or more solvent(s) and one or more analyte(s) that may be present in the sample 112, thereby permitting better measurement sensitivity to Raman bands of contaminants that may be present in the sample 112 that is currently under study. For extraction processes, or other chemical processes applied to agricultural plant feedstocks, for example, one or more adjustable optical filter configurations may be used to improve the detection and/or measurement of the Raman bands of one or more pesticides and/or one or more herbicides.

As described earlier, the physical location of the adjustable optical filter unit 114 within the Raman analyzer system 100 may be different depending on the particular design constraints, e.g., whether there is room inside an existing spectrometer device to add the adjustable optical filter unit 114. In the Raman analyzer system 100 of FIG. 1A, the adjustable optical filter unit 114 is located in the probe head 102h of the optical probe 106. In this case, an input element of the adjustable optical filter unit 114, typically a free-space aperture but alternatively an optical fiber or waveguide, is positioned to receive a scattered light beam from the sample optic 1060 and an output element of the adjustable optical filter unit 114, also typically a free-space aperture, optical fiber, or waveguide, is coupled to an input aperture of the collection fiber 110, such as, but not limited to, a focusing lens assembly or GRIN (gradient index) lens, for example. In the Raman analyzer system 120 shown in FIG. 1B, the adjustable optical filter unit 114 is located between the probe 106 and the spectrometer of the main analyzer unit 104. In this case, an input aperture of the adjustable optical filter unit 114, typically but not limited to a collimating lens assembly, is coupled to the collection fiber 110 and an output aperture of the adjustable optical filter unit 114, typically but not limited to a focusing lens assembly, is coupled to the input port of the spectrometer via an optical fiber. In the Raman analyzer system 140 shown in FIG. 1C, the adjustable optical filter unit 114 is located in the main analyzer unit 104 and has an input aperture that is coupled to the collection fiber 110, typically but not limited to using a collimating lens assembly and an output aperture that is coupled to the input port of the spectrometer.

In the example embodiments of the Raman analyzer system 100, 120, and 140, the computer 102 includes at least one processor and associated memory for storing program instructions for operating the computer 102 to perform a method of Raman spectral analysis, such as method 200 in FIG. 2, for example. The computer 102 is coupled to the main analyzer unit 104 for generally sending and receiving data. For example, when program instructions related to the teachings herein are executed by the processor of the computer 102, the processor may be configured to control the laser to generate light stimuli and transmit the light stimuli to the sample 112 via the excitation fiber 108 through the probe 106 to the sample 112. The processor is also configured to control the acquisition and digitization of scattered light from the sample 112 that results from the light stimuli being received by the sample 112. The generation of the light stimuli as well as the acquisition and digitization of the resulting scattered light may be done via an analyzer control signal 102a.

In accordance with the teachings herein, the scattered light from the sample 112 may be optically filtered by the adjustable optical filter unit 114 prior to digitization depending on the Raman analysis technique that is being employed by the computer 102, which in turn depends on the nature of the solvent(s) and/or analyte(s) in the sample 112 as well as the characteristics of the sample 112 that are being measured. For example, if a chemical extraction system is using superfluid carbon dioxide for one extractant/analyte and then the system is switched at a given time to use isopropanol for a different extractant/analyte, the optical filter unit 114 may be switched from a filter combination that blocks the main Raman bands of carbon dioxide to a filter combination that block the main Raman bands of isopropanol, as described previously, at the given time. In another example, if the temperature of the sample increases as part of a chemical extraction process, Raman bands of the solvent may shift spectrally in their wavelength or wavenumber, and the adjustable optical filter unit 114 may be switched to a different optical filter combination when the temperature of the sample changes in order to more effectively block the main Raman bands of the solvent at their shifted wavelengths or wavenumbers. Accordingly, in at least one embodiment, the computer 102 may send a filter control signal 102b to the adjustable optical the filter unit 114 to select and position one or more optical filters for optically filtering the returning scattered light in the collection light beam path from the sample 112. In alternative embodiments, the computer 102 might not generate the filter control signal 102b and a user may instead manually select and position one or more of the optical filters for filtering the returning scattered light from the sample 112. In at least one embodiment, the adjustable optical filter unit 114 may be adjusted, either automatically under computer control or manually, such that there may be no optical filtering of the return scattered light according to the measurement method that is being used. Raman measurements without filtering may be advantageous, for instance, if the solvent has been removed from the spectroscopic measurement location, leaving only the extractant/analyte, such that interference from the strong Raman bands of the solvent is no longer a problem, and direct Raman measurements of the extractant/analyte can be made without filtering.

The specific choice of which spectral ranges need to be attenuated—either suppressed (e.g., reduced in optical intensity, for example by about 1% to about 99.99%) or blocked completely (e.g., reduced in intensity by more than about 99.99%)—and thus which specific one or more optical filters of the adjustable optical filter unit 114 to place in the collection light beam path (i.e., the optical path of the scattered light beams that return from the sample 112), may be determined a priori by chemists or spectroscopists familiar with the Raman spectral signatures of the solvents, analytes, and/or contaminants that are relevant for a given extraction process or other chemical process which provides the sample 112. The computer 102 may then be used to automatically select among the installed filter options as part of a programmed sequence in accordance with one or more measurement methods (which employ optically filtering one or spectral regions) described herein. This may involve the use of one or more look up tables that are stored in the memory of the computer 102 and indicate which one or more optical filters are used according to the parameters that may be measured from the sample 112. For example, in at least one embodiment the computer 102 may use an algorithm to autonomously make an assessment of the initial Raman spectrum by comparing certain measurements from the Raman spectrum with one or more criteria and then selecting one or more appropriate optical filters to allow for the measurement of certain data for subsequent Raman spectra. By way of a non-limiting example, if an extraction apparatus is configured to use any one of three different solvents, the computer 102 may be programmed to acquire an initial unfiltered Raman spectrum, identify which of the three solvents was being used on the basis of the wavelength or wavenumber positions of the strongest peaks in the initial Raman spectrum, and then send a signal to the adjustable optical filter unit 114 to select an optical filter configuration which blocks the main peaks of the identified solvents.

In at least one embodiment, the computer 102 may also control the spectrometer of the main analyzer unit 104 for generating Raman spectra of scattered light from the sample 112, which may or may not be filtered in accordance with the teachings herein, and then analyze certain characteristics of the sample 112 to determine whether sample acquisition should continue, and in some cases whether sample extraction may continue by comparing the analyzed characteristics with one or more thresholds. By way of example, which is non-limiting, if users wish to perform the extraction process of an extractant/analyte until 95% of the extractant/analyte has been removed from the sample 112, the Raman bands of the analyte can be measured at the start of the process, and then monitored as the process continues, with the computer 102 being programmed to sound an alarm or automatically stop the extraction process when the Raman bands of the analyte have decreased to about 5% of their initial intensity, indicating that only about 5% of the original analyte concentration remains in the sample. In this fashion, one may avoid wasting valuable time on a sample which will yield diminishing returns of extractant/analyte. Other examples of characteristics which may be relevant to efficient process operation include, but are not limited to, monitoring the concentration of the solvent(s) in an extraction progress to make sure they are above a desired threshold, monitoring the concentration of catalysts in a general chemical process to make sure they are above a desired threshold required for effective catalysis, and/or verifying that the concentration of contaminants or by-products is below a desired threshold as required by industry regulations, for example.

The computer 102 is a computing device that can be used by the Raman analyzer system 100 to perform measurements and/or analysis of certain aspects of a sample. In various embodiments, the computer 102 may be a laptop computer or a desktop computer, an embedded computer, or a programmable logic controller (PLC).

Referring now to FIG. 2, shown therein is a flow chart of an example embodiment of a Raman spectral analysis method 200 that incorporates adjustable optical filtering. At act 202, the method 200 includes acquiring one or more initial Raman spectra which may be full spectra (i.e., without any additional optical filtering provided by the adjustable optical filter unit 114). At act 204, the method 200 involves selecting a filter configuration for the adjustable optical filter unit 114 for suppressing or blocking one or more regions of the Raman spectra. At act 206, the method 200 involves selecting data acquisition parameters for influencing certain regions of the Raman spectra such as improving data quality for certain wavelength or wavenumber regions. At act 208, the method 200 involves obtaining one or more Raman spectra over a partial spectral range due to the selected optical filtering that is being provided by the adjustable optical filter unit 114. At act 210, it is determined whether additional optical filtering is to be performed for obtaining additional Raman spectra using different optical filter configurations and/or different values for certain acquisition parameters. If this determination is true, then the method 200 performs acts 204 to 208 again while using the different optical filter configurations and/or different values for certain acquisition parameters. If the determination at act 210 is false, then the method 200 moves to act 212 where the acquired Raman spectral data may be used to assess the status of the extraction process or other chemical process and take appropriate action, either automatically or manually, such as, but not limited to, continuing the process to extract additional analyte, stopping the extraction process, adjusting the temperature or pressure within the chemical reactor apparatus (which may strongly influence the speed or efficiency of the extraction process or chemical process), adding additional feedstock, or adding additional solvent. If the determination at act 214 is false, then the method 200 ends. If the determination at act 214 is true, then the method 200 performs steps 202 to 216 again.

By way of a non-limiting example, a typical Raman measurement sequence may involve performing the following steps, which may be done under computer control. The extraction process may be for extracting resins or oils of commercial value from a feedstock material, with Raman spectroscopy analysis measurements being used to adjust the extraction process to isolate the greatest amount of valuable product (e.g., resins or oils) in the least amount of time. The steps may be performed after the extraction process has started within which samples are provided to the focal region of the sample optic 1060 of the probe 106 of the Raman analyzer system 100. This may be done in situ by positioning the Raman analyzer system 100 adjacent to physical element used in the extraction process at which light can be transmitted from the probe 106 to the sample and light reflections from the sample can be received by the probe 106 while the extraction process is ongoing. Performing Raman measurements in situ may be much safer and more convenient for the extraction process operator. For example, the sample may flow past the focal region of the sample optic 1060 which may be located at a position within or proximal to an extraction apparatus, such as a reactor vessel in which the sample optic 1060 is immersed, a pipe connecting different reaction vessels where the sample optic 1060 is immersed in the pipe, or the laser excitation light beam from the sample optic 1060 may be focused through a window installed on a side of a reactor vessel or connecting pipe. Alternatively, in at least one embodiment, various samples may be illuminated by the excitation light beam and the collected scattered light beams may be analyzed by the Raman analyzer system 100 ex situ.

The steps of this example Raman measurement sequence may involve:
1. Switching the configuration of the adjustable optical filter unit 114 such that no blocking filter is in the collection light beam path (e.g., the returning scattered light from the sample 112), enabling the spectrometer to collect spectral data over a full Raman spectral range including the fingerprint region and the CH stretch region.
2. Acquiring one or more Raman spectra covering the full spectral range of the spectrometer using a short exposure time such as, for example, an exposure time of about 100 to 500 milliseconds (ms) in duration to avoid saturating the detector of the Raman spectrometer.
3. Switching the configuration of the adjustable optical filter unit 114 so that an optical filter which blocks the 1240 to 1440 cm⁻¹ Raman spectral range is in the collection light beam path, suppressing the strong Raman peaks of supercritical CO₂ while permitting Raman bands of the analytes at 1100 cm⁻¹ to be measured.
4. Setting the data acquisition settings for a longer exposure time, for instance about 1,000 to 5,000 ms, e.g., 10 times longer than step 2, to increase the sensitivity of the spectral measurement and thus improve data quality for the analyte bands. Alternatively, other methods may be used to increase the sensitivity of the spectrometer, such as changing the gain amplification factor of the CCD electronics, or enabling an image intensifier or electron-multiplying apparatus that is coupled to the CCD.
5. Acquiring one or more Raman spectra which includes a partial spectral range (which may be referred to as a first partial spectral range) that is not blocked by any optical filters of the adjustable optical filter unit 114.
6. Optionally, doing the following:
   a. Switching to an optical filter in the adjustable optical filter unit 114 which blocks the 800 to 1800 cm⁻¹ Raman spectral range (a larger spectral region than described in step 3), suppressing both the strong Raman peaks of supercritical CO₂ and the Raman bands of the analytes at 1100 cm⁻¹.
   b. Setting the data acquisition settings for even longer exposures, for example about 10,000 to 50,000 ms (e.g., 10 times longer than step 4), to be able to detect the very faint Raman bands of pesticide contaminants at 700 cm⁻¹ and 2300 cm⁻¹. It should be noted that the exposure time length depends on the strengths of the un-blocked Raman bands, which depends on what is being measured for the sample 112, however a 10× increase compared to the exposure time used in step 2 represents an increase of exposure time, which may be typically used.
   c. Acquiring one or more Raman spectra over a spectral range which may be referred to as a second partial spectral range.
7. Using the Raman spectral data to monitor and/or control the extraction process, for instance determining whether the extraction process is still performing as expected, and/or whether the process may continue or be halted. By way of example, from the initial Raman spectra covering the full Raman range, the bands of supercritical CO₂ can be used to verify that the supercritical CO₂ solvent is present at a desired density (e.g., by comparing one or more peak amplitudes and/or one or more band areas of the Raman spectra to respective thresholds) and purity so that the most efficient extraction process is being performed. From the Raman spectra covering the first partial spectral range (e.g., due to the optical filtering provided by one configuration the adjustable optical filter unit 114), the peak amplitude and/or area of the Raman bands of the analytes being extracted can be monitored to quantify the decrease in the analyte concentration as the extraction proceeds, and a signal can be sent to the extraction equipment operator when the analyte concentration has dropped below a predetermined threshold where further extraction will not yield any more value (e.g., the amount of analyte being extracted is not sufficient to support the costs of performing ongoing extraction). In addition, in some cases, depending on the nature of the materials being extracted in the extraction process, based on one or more peak amplitudes and/or areas in the Raman spectra covering the second partial spectral range, the presence of pesticide contamination may be monitored based on comparison to respective thresholds, and an audible alarm may be generated if pesticides are detected, so that the extracted analytes may be subjected to additional safety testing and discarded if the contamination level is too high.
8. Repeating the sequence of steps 1 to 7 as required while the extraction process continues.

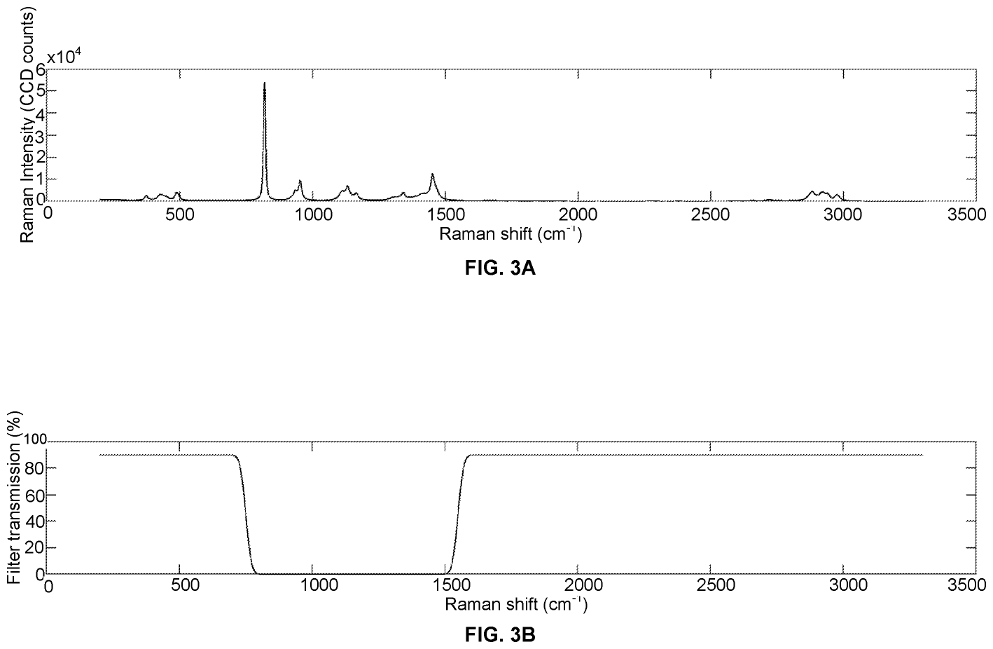

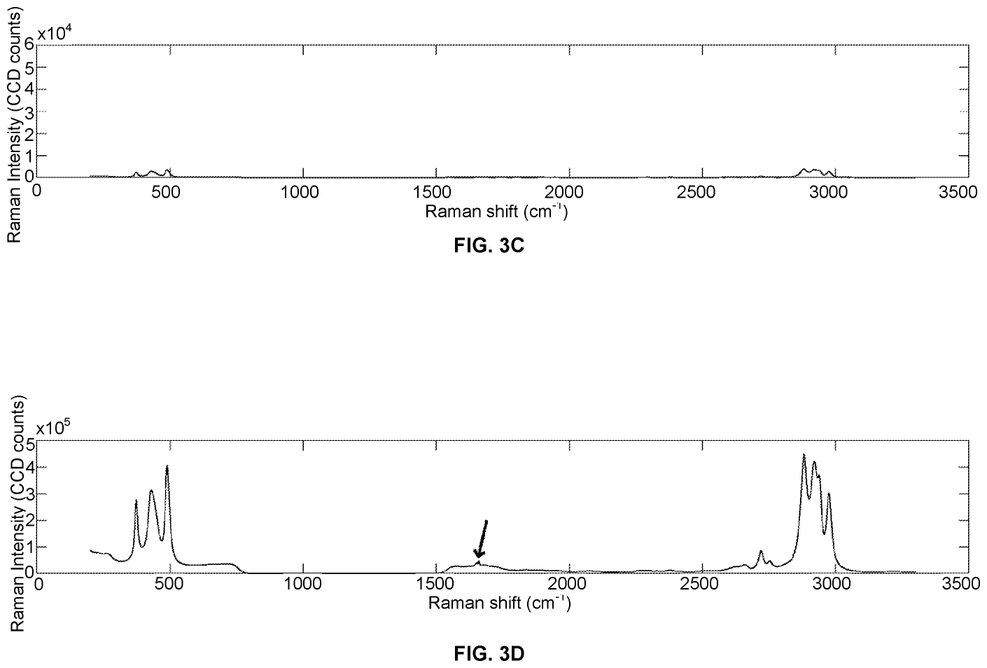

By way of another non-limiting example, FIGS. 3A to 3D show how the addition of a blocking optical filter, that is manufactured specifically to attenuate the strong peaks of the solvent isopropanol, can improve the measurement of weak Raman bands of an analyte. FIG. 3A shows a Raman spectrum of a mixture that is 99% isopropanol and 1% analyte, collected with a 50 millisecond exposure time. All visible bands in the spectrum are due to isopropanol, with a small double-peak band of the analyte at 1655 cm⁻¹ being invisible and thus unquantifiable. If the exposure time were increased to increase the height of the analyte band this may cause the strong isopropanol bands to saturate the CCD detector of the spectrometer of the main analysis unit 100 and ruin the measurement. FIG. 3B shows the optical transmission curve for a notch optical filter which blocks all light between 800 and 1500 cm⁻¹, corresponding to the strongest isopropanol bands in a so-called fingerprint region. If this notch optical filter is inserted into the collection beam path of the Raman system by configuring the adjustable optical filter unit 114 (which may be done according to one of the techniques described herein), and another 50 millisecond exposure is acquired, the resulting spectrum (FIG. 3C) no longer shows the strong bands of isopropanol, as those wavelengths are blocked or strongly attenuated by the notch optical filter. However, the bands of the analyte are still too faint to measure precisely. FIG. 3D shows another spectrum of the mixture with a longer exposure time, 5 seconds in duration, which increases the measured strength of the entire spectrum. The strong bands of isopropanol in the 800-1500 cm⁻¹ range do not saturate the CCD detector because they are blocked by the notch optical filter, but the weaker bands of isopropanol at 350-500 cm⁻¹ and the CH stretch region are clearly visible, and the small band of the analyte at 1655 cm⁻¹ (marked with an arrow) is now visible and measurable by standard spectral analysis algorithms such as peak area, peak profile fitting, or partial least squares, thereby permitting monitoring of the status of the extraction process.

In at least one embodiment, one or more optical filters in the adjustable optical filter unit 114 may comprise one or more tunable optical filters whose spectral blocking and transmission ranges (e.g., attenuation and/or passband regions) can be adjusted to achieve the same configurability as an optical filter wheel or an optical filter sliding stage. These tunable optical filters may comprise one or more of: an acousto-optic tunable filter (AOTF), a liquid-crystal-based tunable filter, a grating-based tunable filter, other tunable optical filter mechanism, or a combination thereof.

In at least one embodiment, the one or more tunable optical filters may be positioned in the collection light beam path and the passband and stopbands adjusted to provide the desired optical suppression or no suppression at all depending on the measurements that are being taken. Alternatively, the one or more tunable optical filters may be moved into and out of the light collection beam path.

In at least one embodiment, the one or more optical filters may include a combination of at least one fixed optical filter and at least one tunable optical filter. A fixed optical filter is one whose spectral filtering characteristics are fixed (e.g., do not change) after manufacture.

In at least one embodiment, the one or more optical filters, which may include any combination of at least one fixed optical filter and at least one tunable optical filter, may be configured such that the adjustable optical filter unit may suppress, block, and/or transmit different light wavelengths corresponding to one or more regions of a Raman spectrum, depending on passband characteristics of these optical filters.

In at least one embodiment, one or more optical filters in the adjustable optical filter unit 114 may include a dichroic filter, also known as a dichroic beamsplitter, which reflects some wavelengths of an optical beam while transmitting other wavelengths. By using a dichroic filter, the Raman analyzer system 100 may allow for the transmission of different spectral regions of the Raman spectrum to different spectrometers, or different pathways through one spectrometer, to permit simultaneous measurement of both solvent Raman bands and analyte Raman bands.

Raman spectrometers most commonly examine spectral ranges with longer wavelengths compared to the wavelength(s) of the light stimuli generated by the excitation laser that is used, where the Raman bands are caused by so-called “Stokes shifted” photons scattering from the sample molecules. Depending on the characteristics of the sample (such as susceptibility to fluorescence), in at least one embodiment in accordance with the teachings herein a spectrometer and at least one optical filter can be used which enable monitoring the Stokes-shifted Raman bands of the sample, or the corresponding anti-Stokes-shifted bands which are found at shorter wavelengths compared to the wavelength(s) of the light stimuli generated by the excitation laser, or a combination of the Stokes and anti-Stokes bands. By way of example, for a 785 nm excitation laser, the Stokes fingerprint range spans 798 to 914 nm, while the anti-Stokes fingerprint range spans 688 to 773 nm. To cover both of these ranges, switchable optical filters in the adjustable optical filter unit 114 may be configured to transmit scattered light with wavelengths within these two ranges, and the spectrometer may be designed or configured to focus light beams at all of these wavelengths onto different points on the CCD detector. The Stokes and anti-Stokes spectral ranges generally contain the same chemical information, but depending on the properties of the sample mixture, specific chemicals may be easier to detect and measure in either the Stokes or anti-Stokes ranges. Furthermore, the relative strength of the same chemical Raman band determined by obtaining measurements in the Stokes range and the anti-Stokes range and comparing these measurements to one another (perhaps through a ratio) can be used to determine the temperature of the sample, which is a useful parameter to monitor (and possibly be used to control) an extraction process.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method of analyzing a chemical process including a supercritical fluid extraction process or a solvent extraction process, using a Raman analyzer system, wherein the method comprises:
generating a light stimuli and providing the light stimuli to a sample of the chemical process;
collecting scattered light from the sample;
performing filtering prior to collecting the scattered light or after collecting the scattered light using one or more optical filters for selectively attenuating at least one wavelength region that corresponds to one or more Raman bands of one or more solvents, analytes, and/or contaminants;
detecting the filtered light; and
generating one or more filtered Raman spectra of the detected light.

2. The method of claim 1, where the solvent comprises C3-8 alcohol, a hydrocarbon, a supercritical fluid, ethanol, isopropanol, butane, acetone, a hydrofluorocarbon, R-134a, n-propane, isopropane, cyclopropane, n-butane, isobutane, hexane, pentane, isobutylene, glycerin, propylene glycol, supercritical carbon dioxide, or any combination thereof.

3. The method of claim 1, wherein the one or more optical filters comprise an adjustable optical filter unit having one or more shortpass optical filters, one or more longpass optical filters, one or more notch optical filters, or any combination thereof which attenuate at least a portion of the one or more Raman spectra over one or more continuous or discontinuous spectral ranges.

4. The method of claim 1, wherein the method comprises moving the one or more optical filters in and out of a collection light beam path or a scattered light beam path from the sample when performing filtering.

5. The method of claim 4, wherein the method comprises moving the one or more optical filters by means of a rotating filter wheel or a translating filter stage, and/or the method comprises using a computing device or an automatic sequencing apparatus to generate a filter control signal for controlling motion of the one or more optical filters.

6. (canceled)

7. The method of claim 1, wherein the one or more optical filters include at least one tunable optical filter and the method comprises using a computing device or an automatic sequencing apparatus to generate a filter control signal to change a passband and/or attenuation region of the at least one tunable optical filter.

8. The method of claim 1, wherein the method comprises configuring the one or more optical filters to attenuate the one or more Raman bands of one or more solvents and/or one or more analytes in the sample in order to detect Raman bands of contaminants in the sample obtained from the chemical process; and/or the method comprises selecting the one or more optical filters to attenuate one or more wavelength ranges during filtering so that the generated Raman spectra only include one or more Stokes-shifted Raman bands or one or more anti-Stokes shifted Raman bands.

9. (canceled)

10. The method of claim 1, wherein prior to performing filtering, the method further comprises:
acquiring one or more full Raman spectra from the sample without performing the selective attenuation; and
selecting one or more data acquisition parameters and/or a configuration for the one or more optical filters based on one or more characteristics of the one or more full Raman spectra.

11. The method of claim 10, wherein after generating the one or more full Raman spectra the method further comprises determining whether to acquire additional full Raman spectra without performing any selective attenuation, while selecting other values for data acquisition parameters and/or another configuration for the one or more optical filters based on positions, amplitudes, and/or other characteristics of bands and/or peaks which appear in the additional full Raman spectra.

12. The method of claim 1, wherein the method further comprises monitoring and/or controlling the chemical process using chemical information derived from the one or more filtered Raman spectra.

13. The method of claim 1, wherein the method comprises:
acquiring Raman spectral data using a first optical filter configuration for the one or more optical filters to permit measurement of a Raman spectral range;
acquiring one or more additional Raman spectral data using a second optical filter configuration that is different than the first optical configuration to block Raman bands of one or more solvents or other Raman bands having largest amplitudes in the Raman spectral range, and using one or more additional data acquisition settings to enable one or more additional spectral measurements including using an increased exposure time, and/or change in gain with each additional acquisition of the one or more additional Raman spectral data to permit a partial spectral range including Raman bands of one or more analytes to be measured with an improvement in fidelity; and
determining whether to continue the chemical process and/or perform the analysis based on the Raman spectral data based on a comparison of measurements of the one or more analytes to a threshold.

14. The method of claim 13, wherein the method further comprises:
acquiring one or more further Raman spectral data using one or more further optical filter configurations to attenuate the Raman bands of the one or more solvents and/or the one or more analytes, and using one or more other data acquisition settings to enable one or more further spectral measurements including using an increased exposure time and/or change in gain to permit one or more further partial spectral ranges including Raman bands of other potential constituents of the process to be measured.

15. A Raman analyzer system for analyzing a chemical process including a supercritical fluid extraction process or a solvent extraction process, wherein the Raman analyzer system comprises:
a light source that is configured to generate a light stimuli;
an optical probe that is coupled to the light source for providing the light stimuli to a sample of the chemical process and collecting scattered light from the sample;
an adjustable optical filter unit that is coupled to the optical probe, the adjustable optical filter unit including one or more optical filters for selectively performing filtering prior to collecting the scattered light or after collecting the scattered light by configuring the one or more optical filters for selectively attenuating at least one wavelength region that corresponds to one or more Raman bands of one or more solvents, analytes, and/or contaminants;
a spectrometer that is coupled to the adjustable optical filter unit for detecting the filtered light and generating one or more filtered Raman spectra of the detected light; and
a computing device that is coupled to the spectrometer, the light source and the adjustable optical filter unit and configured for controlling Raman measurements of the sample.

16. The Raman analyzer system of claim 15, wherein the adjustable optical filter unit comprises one or more shortpass optical filters, one or more longpass optical filters, one or more notch optical filters, or any combination thereof, which attenuate at least a portion of the one or more Raman spectra over one or more continuous or discontinuous spectral ranges.

17. The Raman analyzer system of claim 15, wherein the one or more optical filters are moveable into and out of a collection light beam path or a scattered light beam path from the sample when performing filtering.

18. The Raman analyzer system of claim 17, wherein the adjustable optical filter unit comprises a rotating optical filter wheel or a translating optical filter stage for moving the one or more optical filters; and/or the computing device is configured to generate a filter control signal for controlling motion of the one or more optical filters.

19. (canceled)

20. The Raman analyzer system of claim 15, wherein the adjustable optical filter unit comprises one or more tunable optical filters that are tunable to suppress, block, and/or transmit different light wavelengths corresponding to one or more regions of a Raman spectrum, and/or the computing device is configured to generate a filter control signal to change a passband and/or attenuation region of the at least one tunable optical filter.

21. (canceled)

22. The Raman analyzer system of claim 15, wherein the computing device is adapted to configure the one or more optical filters to attenuate the one or more Raman bands of one or more solvents and/or one or more analytes in the sample in order to detect Raman bands of contaminants in the sample obtained from the chemical process.

23. The Raman analyzer system of claim 15, wherein the one or more optical filters are configured to attenuate one or more wavelength ranges during filtering so that the generated Raman spectra only include one or more Stokes-shifted Raman bands or one or more anti-Stokes-shifted Raman bands.

24. The Raman analyzer system of claim 15, wherein the adjustable optical filter unit is located in the optical probe, in the spectrometer, between the optical probe and the spectrometer, or a combination thereof.
